(19) United States
(12) Patent Application Publication
(10) Pub. No.: US 2002/0017390 A1
(43) Pub. Date: Feb. 14, 2002

(54) Temperature-resistant communications cable

(75) Inventors: Paul Gregor, Oberhausen (DE); Klaus Nothofer, Erkrath (DE)

Correspondence Address: SUGHRUE, MION, ZINN, MACPEAK & SEAS, PLLC, 2100 Pennsylvania Avenue, NW, Washington, DC, 20037-3213, US

(73) Assignee: ALCATEL

(21) Appl. No.: 09/924,716

(22) Filed: Aug. 9, 2001

(30) Foreign Application Priority Data
Aug. 11, 2000 (DE) 100 39 274.1

(51) Int. Cl. H01B 9/00

(52) U.S. Cl. 174/28

(57) ABSTRACT

In the laying of communications cables in the interior of pipes, in which hot substances are conveyed, it is important to provide communications cables of this type with long-term protection against the surrounding aggressive heat. The communications cable is not laid directly in contact with this aggressive hot environment in that at least one continuous cavity is arranged around the cable core of the said communications cable, which cavity is sealed by a sleeve. In order to be able to extract heat which inevitably diffuses over time from the hot environment into the said cavity, a medium is advantageously conveyed through the cavity. Only in this way is it possible to maintain a constant temperature around the cable core on a long-term basis and to accordingly obtain a long-life communications cable laid, for example, in district heating pipes.

### TECHNICAL FIELD

The invention relates to a communications cable with a cable core and a sleeve enclosing the said cable core, for laying in already existing pipelines and a method for cooling a communications cable, which is laid in an already existing pipeline, which is used for conveying hot substances. The invention is based on a priority application (100 39 274.1) which is hereby incorporated by reference.

### BACKGROUND OF THE INVENTION

In communications cables, there is an increasing search for alternatives in order to minimise the cost of laying the cables. In this respect, already existing pipeline routes, such as sewers, for example, have been used, in which communications cables have been laid. Several problems arise in this case, such as the introduction of the communications cable into ducts of this type. The problems are not always simple to solve. This in turn generates costs, which renders the economic viability of such alternative projects questionable.

In contrast to sewers, thermally insulated pipelines of a district heating network, for example, are often laid above ground. In addition, district heating networks, in contrast to the sewer networks, sometimes follow other routes which are also of interest for communications cables. Consequently, the laying of communications cables in thermally insulated pipelines has been tested and developed. Other problems have been encountered here, particularly in relation to the high temperature of the environment in which the communications cable lies.

Heat-resistant communications cables have long been state of the art. In this respect, the main concern is to ensure that communications cables of this type continue to function for as long as possible in the event of fire. Communications cables of this type, as disclosed in DE 299 13 737 for example, can only withstand very high temperatures for a given period of time.

Consequently, it is not possible to lay heat-resistant communications cables of this type in district heating pipes, since in this case the communications cables are continuously confronted with a heat source. In DE 298 00 181, a communications cable is disclosed which is to be fitted onto district heating pipes. However, in this specification the communications cable is not laid within the district heating pipe, but outside the pipe in the thermal insulation layer surrounding the district heating pipe. This offers the advantage that the communications cable does not come into direct contact with the heat source. However, it is not always possible to introduce communications cables into thermal insulation layers of district heating pipes in a simple manner. Often there is not even sufficient space available, since the said thermal insulation layer should actually be completely filled, for example with an insulating glass fibre material, in order to prevent a dissipation of heat.

### SUMMARY OF THE INVENTION

It is the object of the invention to further develop a communications cable which continues to be heat-resistant on long-term basis so that it can survive, typically in the interior of district heating pipes.

This object is attained according to the invention by a communications cable with a cable core and a sleeve enclosing the said cable core, for laying in already existing pipelines, comprising at least one continuous cavity along the cable core, the said cavity being sealed by the surrounding sleeve and by a method for cooling a communications cable which is laid in an already existing pipeline, which is used for conveying hot substances, the communications cable comprising at least one continuous cavity along its cable core, which is sealed off by a surrounding sleeve, and for cooling the communications cable a medium is conveyed through the said cavity, which medium extracts heat which has penetrated the communications cable.

In the laying of communications cables within pipes, in which hot substances are conveyed, such as in district heating pipes, for example, it is important to provide communications cables of this type with long-term protection against the surrounding aggressive heat. It is therefore the best solution if the communications cable is not laid directly in contact with this aggressive hot environment. This is attained in that at least one continuous cavity is arranged around the cable core of the said communications cable, which cavity is sealed by a sleeve. In order to be able to extract heat which inevitably diffuses over time from the hot environment into the said cavity, a medium is advantageously conveyed through the cavity. Only in this way is it possible to maintain a constant temperature around the cable core on a long-term basis. Depending on the temperature of the conveyed hot substances in the pipelines in which the communications cable is laid, it is possible to choose between particular media having different levels of thermal conductivity. The simplest choice, of course, is the use of a gas such as air or a fluid such as water.

Advantageous developments of the invention will be clear from the dependent claims, the following description and the drawings.

### BRIEF DESCRIPTION OF THE DRAWINGS

An embodiment of the invention will now be explained in further detail with the aid of the attached drawings, in which:

FIG. 1 is a cross section through a communications cable according to the invention,

FIG. 2 is a cross section through an alternative communications cable according to the invention.

### BEST MODE FOR CARRYING OUT THE INVENTION

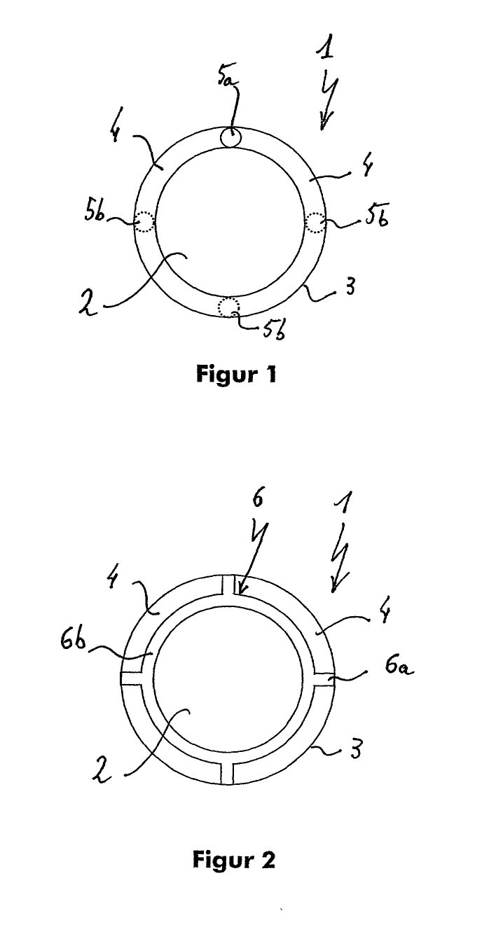

In both FIGS. 1 and 2, a cross section through a communications cable 1 is illustrated. Disposed in the centre is the cable core 2 of the said communications cable 1, which is not shown in detail here. A plurality of possibilities for the cable core 2 are conceivable depending on the application of the said communications cable, for example lightwave conductors only in the case of a purely optical communications cable 1. However, a mixture of lightwave conductors and copper conductors is also conceivable, as well as a communications cable comprising only copper conductors. This invention is particularly suitable for communications cables comprising at least some lightwave conductors, since the latter are not as heat-resistant as copper conductors.

Formed around the cable core 2 along the longitudinal axis is at least one cavity 4. This is obtained by means of spacing elements, which are distributed along the cable core and on the outer surface of said cable core and which support a sleeve 3 wrapped around the cable core. This sleeve 3 is used for sealing the cavity 4.

A medium, which is intended to protect the cable core against the penetrating heat, is then conveyed in the said cavity 4. In the embodiment of FIG. 1, the said spacing element is formed by a single plastics material tube 5a. The plastics material tube 5a is accordingly wrapped around the cable core 2 in the manner of a helix in order to support the sleeve 3 at a uniform distance.

It is entirely possible to use a plurality of plastics material tubes 5a, 5b of this type, as is indicated in FIG. 1 by the three additional plastics material tubes 5b. In this case, it is advantageous to distribute the plastics material tubes uniformly over the circumference of the cable core. It is then no longer necessary in this case to wind the plastics material tubes 5a, 5b helically onto the cable core 2. In fact, they may be positioned perfectly well along the cable core without winding and as few as three plastics material tubes could suffice in this case, offset through 120° in each case.

In the embodiment in FIG. 2, the spacing elements are formed by webs 6, 6a, 6b, which are extruded around the cable core in the manufacture of the cable core using the conventional method. In this respect, a shell 6b is formed directly around the cable core 2, the webs 6a being extruded together with, and in, the shell 6b. The webs 6a may also be moulded helically along the longitudinal axis of the cable core 2, but are usually moulded without winding. The sleeve 3, which in this embodiment in FIG. 2 thus seals off four cavities defined by the four webs 6a, is then moulded onto the webs.

The sleeve 3 may be formed by strips, which are wound onto the spacing elements. Advantageously, the sleeve 3 may also be manufactured from a welded or pressed metallic material. To this end, a material such as steel, copper or aluminium, amongst others, may be used. If necessary, this metallic tube can be corrugated. The sleeve 3, which seals of the cavity or the plurality of cavities 4 can be manufactured with particular care in order to produce a completely hermetic seal.

A medium is then conveyed in one or more continuous cavities 4, which extracts the heat which has penetrated the communications cable. To this end, a gas such as air or nitrogen, for example, can be used as the medium. It is entirely possible to use a fluid such as water or a CFC substitute coolant as the medium. The selection of the medium having different levels of thermal conductivity is dependent on the temperature of the substances conveyed in the pipeline in which the communications cable 1 is laid.

The invention presented above is not merely restricted to communications cables which are to be laid in district heating pipes, but generally applies to communications cables which are laid in already existing pipeline routes in which hot substances are conveyed. In this manner, an already existing network of pipes is advantageously used in order to construct a new telecommunications network with the aid of communications cables of this type.

1. A communications cable with a cable core and a sleeve enclosing the said cable core, for laying in already existing pipelines, comprising at least one continuous cavity along the cable core, the said cavity being sealed by the surrounding sleeve.

2. A communications cable according to claim 1, the cavity being formed by at least one plastics material tube, which is helically wound onto the cable core, the sleeve being fitted onto the plastics material tube.

3. A communications cable according to claim 1, the cavity being formed by at least three plastics material tubes, which are positioned longitudinally on the cable core, the sleeve being fitted onto the plastics material tubes.

4. A communications cable, the cavity being formed by at least one web, which is extruded onto the cable core, the sleeve being fitted onto the web.

5. A communications cable according to claim 1, the sleeve being formed by a welded or pressed metallic tube.

6. A communications cable according to claim 1, the sleeve being formed by a corrugated tube.

7. A method for cooling a communications cable, which is laid in an already existing pipeline, which is used for conveying hot substances, the communications cable comprising at least one continuous cavity along its cable core, which is sealed off by a surrounding sleeve, and for cooling the communications cable a medium being conveyed through the said cavity, which medium extracts heat which has penetrated the communications cable.

8. A method according to claim 7, a gas such as air or nitrogen, for example, being used as a medium for extracting the heat.

9. A method according to claim 7, a fluid such as water or a CFC substitute coolant, for example, being used as a medium for extracting the heat.
